(19) United States
(12) Patent Application Publication
(10) Pub. No.: US 2012/0290485 A1
(43) Pub. Date: Nov. 15, 2012

(54) AUTOMATED NEGOTIATION

(76) Inventors: Mohmel Kivanc Ozonat, San Jose, CA (US); Sharad Singhal, Belmont, CA (US)

(21) Appl. No.: 13/107,108

(22) Filed: May 13, 2011

(51) Int. Cl. G06Q 20/00

(52) U.S. Cl. 705/80

(57) ABSTRACT

A probability that an opposing party in a negotiation will accept the terms of a candidate offer within a given number of rounds of the negotiation may be computed, and the candidate offer may be identified as an offer to present to the opposing party based on the computed probability.

### BACKGROUND

Electronic commerce technologies enable consumers to purchase products and services from businesses online.

### BRIEF DESCRIPTION OF THE DRAWINGS

FIGS. 1A and 1B are schematic diagrams of an example user interface for interacting with an automated negotiation agent.

FIG. 2 is a block diagram of an example of a communications system.

FIG. 3 is a graphical representation of an example of a party's negotiation behavior.

FIGS. 4 and 5 are flowcharts illustrating examples of aspects of processes for building a negotiation behavior model.

FIG. 6 is a flowchart illustrating an example of a process for conducting an automated negotiation.

FIGS. 7-8 are flowcharts illustrating examples of processes for identifying offers to be presented to opposing parties in automated negotiations.

### DETAILED DESCRIPTION

An automated negotiation agent conducts negotiations with human counterparts. During such automated negotiations, the automated negotiation agent may use prediction models that model future trajectories of offers to be made by the human counterparts in the issue space of the transaction being negotiated to compute probabilities that the future trajectories of offers to be made by the human counterparts will intersect certain targets of the automated negotiation agent. For example, the automated negotiation agent may use a switching linear dynamical system (SLDS) to model the future trajectory of offers to be made by a human counterpart and to compute probabilities that the future trajectory of the human counterpart's offers will intersect targets of the automated negotiation agent. The automated negotiation agent then may use these probabilities to inform its strategy for presenting counteroffers to its human counterparts.

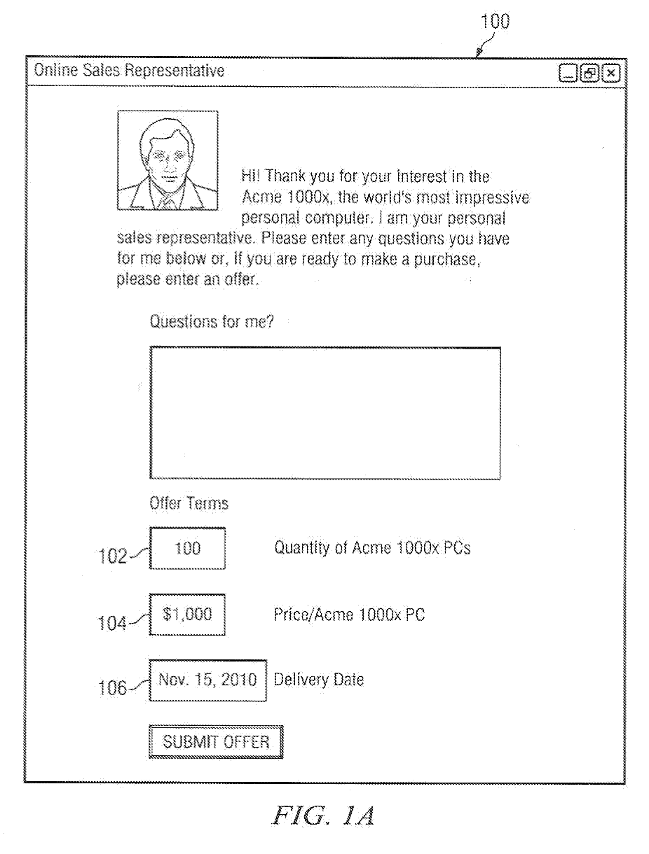

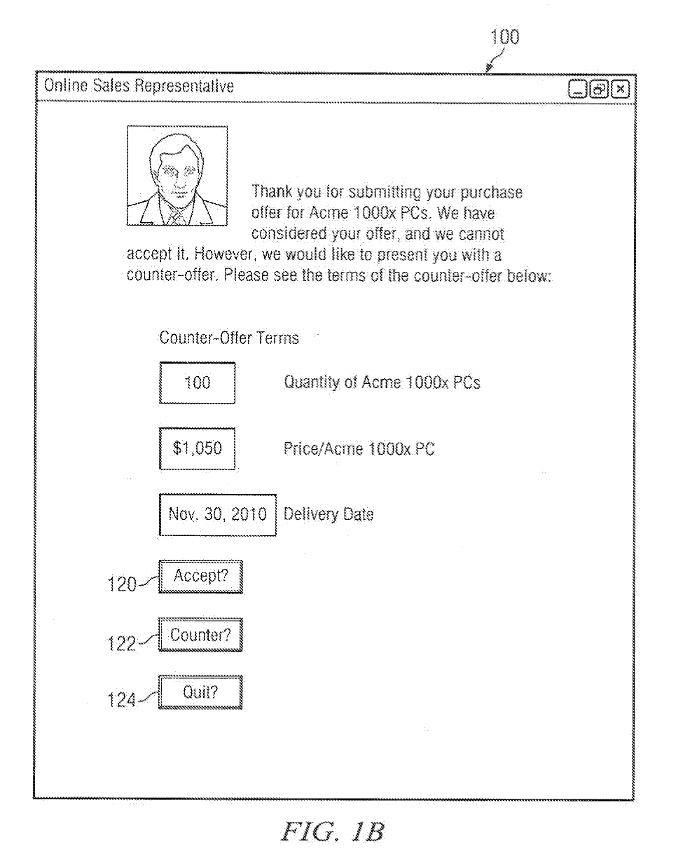

FIGS. 1A and 1B are schematic diagrams of an example user interface 100 for interacting with an automated negotiation agent. The automated negotiation agent, which may be implemented as one or more applications executing on one or more servers or other computing devices, is configured to engage, on behalf of a business, in a negotiation over different terms of a transaction with a human counterpart. For example, the automated negotiation agent may be able to receive and evaluate offers submitted by a human counterpart, enabling the automated negotiation agent and the human counterpart to engage in a back and forth exchange of offer and counteroffer until the automated agent and the human counterpart are able to agree upon terms of the transaction or until one party decides to terminate the negotiation.

As illustrated in FIGS. 1A and 1B, the automated negotiation agent is configured to negotiate the terms of the sale of one or more personal computers with a human counterpart, and the user interface 100 enables a user to submit terms of an initial offer to the automated agent. In particular, the user interface 100 includes a quantity field 102, a unit price field 104, and a delivery date field 106 that enable the human counterpart to propose a quantity of personal computers to be purchased, a unit price for each personal computer, and a delivery date, respectively, as the terms of an initial offer. As illustrated in FIG. 1A, the human counterpart has proposed to purchase 100 personal computers at a purchase price of $1,000 per personal computer, with a delivery date for the personal computers of Nov. 15, 2010.

In response to receiving the terms proposed by the human counterpart, the automated agent considers the terms proposed by the human counterpart and determines if the terms are acceptable to the business on behalf of whom the automated negotiation agent is negotiating. In the event that the automated negotiation agent determines that the terms proposed by the human counterpart are not acceptable to the business that the automated negotiation agent is representing, the automated negotiation agent may determine to make a counteroffer to the human counterpart with terms that are acceptable to the business that the automated negotiation agent is representing. As will be described in greater detail below, the automated negotiation agent may consult a negotiation behavior model that models the trajectories of offers from the human counterpart as part of the process of generating a counteroffer to propose to the human counterpart.

As illustrated in FIG. 1B, the automated negotiation agent decided that the human counterpart's initial proposal to purchase 100 personal computers at a purchase price of $1,000 per personal computer with a delivery date of Nov. 15, 2010 is not acceptable and, therefore, proposed a counteroffer with terms acceptable to the business on behalf of whom the automated negotiation agent is negotiating. In particular, the automated negotiation agent counter-offered by proposing an increased unit purchase price of $1,050 per personal computer and a delayed delivery date of Nov. 30, 2010 for the same quantity of 100 personal computers.

As further illustrated in FIG. 1B, in addition to presenting the terms of the automated negotiation agent's counteroffer to the human counterpart, the interface 100 also provides a selectable control 120 that enables the human counterpart to accept the automated negotiation agent's counteroffer and consummate the transaction, a selectable control 122 that enables the human counterpart to propose a counteroffer to the automated negotiation agent's offer, and a selectable control 124 that enables the human counterpart to terminate the negotiation.

Should the human counterpart decide to propose a counteroffer to the automated negotiation agent's offer by selecting selectable control 122, the human counterpart and the automated negotiation agent can continue the negotiation, going back and further exchanging offers and counteroffers, until the human counterpart and the automated negotiation agent arrive at mutually agreeable terms or until one party decides to terminate the negotiation.

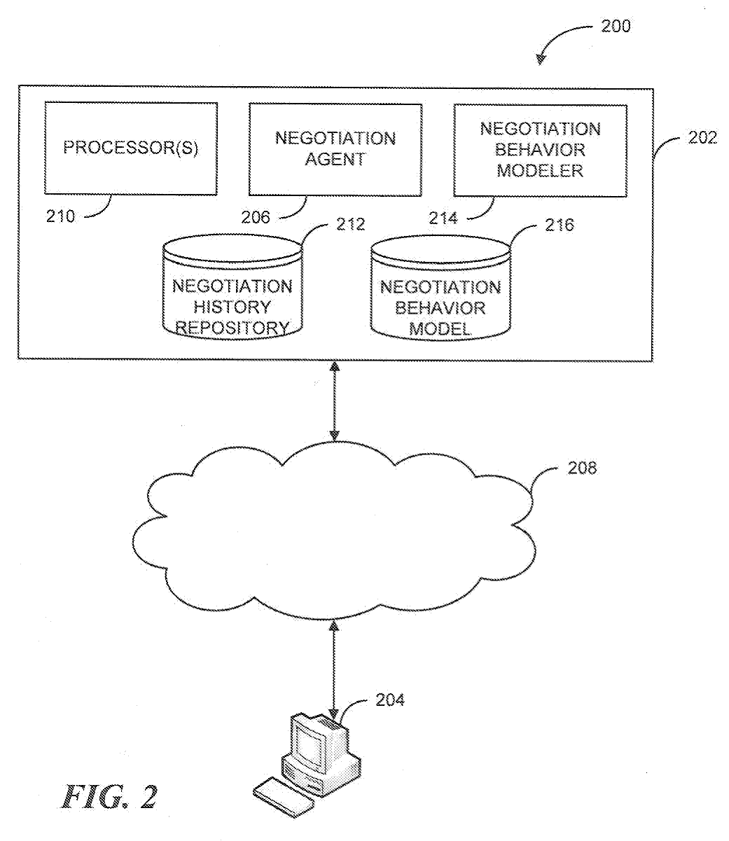

FIG. 2 is a block diagram of an example of a communications system 200, including an electronic commerce complex 202, a client computer 204, and a network 208 that enables a human user of client computer 204 to engage in automated negotiations with an automated negotiation agent 206 executing on electronic commerce complex 202. For illustrative purposes, several elements illustrated in FIG. 2 and described below are represented as monolithic entities. However, these elements each may include and/or be implemented on numerous interconnected computing devices and other components that are designed to perform a set of specified operations and that are located proximally to one another or that are geographically displaced from one another.

As illustrated in FIG. 2, the electronic commerce complex 202 and automated negotiation agent 206 are accessible to client computer 204 over network 208.

Client computer 204 may be any of a number of different types of computing devices including, for example, a personal computer, a special purpose computer, a general purpose computer, a combination of a special purpose and a general purpose computing device, a laptop computer, a tablet computer, a netbook computer, a smart phone, a mobile phone, a personal digital assistant, and a portable media player. Client computer 204 typically has internal or external storage components for storing data and programs such as an operating system and one or more application programs. Examples of application programs include authoring applications (e.g., word processing programs, database programs, spreadsheet programs, or graphics programs) capable of generating documents or other electronic content; client applications (e.g., e-mail clients) capable of communicating with other computer users, accessing various computer resources, and viewing, creating, or otherwise manipulating electronic content; and browser applications capable of rendering standard Internet content and, in some cases, also capable of supporting a web-based e-mail client. In addition, the internal or external storage components for client computer 204 may store a dedicated client application for interfacing with electronic commerce complex 202 and/or automated negotiation agent 206. Alternatively, in some implementations, client computer 204 may interface with electronic commerce complex 202 and automated negotiation agent 206 without a specific client application (e.g., using a web browser).

Client computer 204 also typically includes a central processing unit (CPU) for executing instructions stored in storage and/or received from one or more other electronic devices, for example over network 208. In addition, client computer 204 also usually includes one or more communications devices for sending and receiving data. One example of such a communications device is a modem. Other examples include an antenna, a transceiver, a communications card, and other types of network adapters capable of transmitting and receiving data over network 208 through a wired or wireless data pathway.

Electronic commerce complex 202 may be implemented using one or more computing devices (e.g., servers) configured to provide a service to one or more client devices (e.g., client computer 204) connected to electronic commerce complex 202 over network 208. The one or more computing devices on which electronic commerce complex 202 is implemented may have internal or external storage components storing data and programs such as an operating system and one or more application programs. The one or more application programs may be implemented as instructions that are stored in the storage components and that, when executed, cause the one or more computing devices to provide the features of the electronic commerce complex 202 and/or automated negotiation agent 206 described herein.

Furthermore, the one or more computing devices on which electronic commerce complex 202 is implemented each may include one or more processors 210 for executing instructions stored in storage and/or received from one or more other electronic devices, for example over network 208. In addition, these computing devices also typically include network interfaces and communication devices for sending and receiving data.

Network 208 may provide direct or indirect communication links between electronic commerce complex 202 and client computer 204 irrespective of physical separation between any of such devices. As such, electronic commerce complex 202 and client computer 204 may be located in close geographic proximity to one another or, alternatively, electronic commerce complex 202 and client computer 204 may be separated by vast geographic distances. Examples of network 208 include the Internet, the World Wide Web, wide area networks (WANs), local area networks (LANs) including wireless LANs (WLANs), analog or digital wired and wireless telephone networks, radio, television, cable, satellite, and/or any other delivery mechanisms for carrying data. In some implementations, client computer 204 may be connected to network 208 over a wireless connection (e.g., a WLAN based on the IEEE 802.11 standard, a radio frequency-based wireless network, and/or a cellular or mobile telephony network provided by a wireless service provider) made available by a private service provider.

As illustrated in FIG. 2, electronic commerce complex 202 includes a computer memory storage system 212 storing data about previous negotiations that were conducted with human counterparts. For example, the negotiation history repository stored in computer memory storage system 212 may include records of the offers and counteroffers made as previous negotiations progressed through rounds of negotiations as well as information about offers that ultimately were accepted by both sides.

Electronic commerce complex 202 also includes a negotiation behavior modeler 214 that is configured to access the negotiation history repository stored in computer memory storage system 212 and build one or more models of human negotiation behavior based on the records stored in the negotiation history repository. Negotiation behavior modeler 214 may be implemented as instructions stored in a computer memory storage system that, when executed, cause processor(s) 210 to provide the functionality ascribed herein to the negotiation behavior modeler 214. The model(s) of negotiation behavior generated by negotiation behavior modeler 214 are stored in computer memory storage system 216, from which they are available to negotiation agent 206.

Electronic commerce complex 202 may provide a catalog or other collection of products or services that are available for sale from a business, and a human user of client computer 204 may be able to access and browse such a catalog or other collection of products or services for sale over network 208. In the event that, through the course of browsing the catalog or other collection of products or services that are available for sale, a human user of client computer 204 locates a product or service that the human user is interested in purchasing, the human user may use client computer 204 to communicate that interest to electronic commerce complex 202. In response, automated negotiation agent 206 then may engage the human user of client computer 204 in an automated negotiation over the terms of the transaction, during the course of which the automated negotiation agent 206 and the human user of client computer 204 present offers and counteroffers to one another by exchanging electronic messages over network 208.

While conducting an automated negotiation with a human user of client computer 204, negotiation agent 206 may access a model of human negotiation behavior from computer memory storage system 216 and use the accessed model of human negotiation behavior in an effort to understand and anticipate the negotiation strategies of the human user of client computer 204 as the automated negotiation with the human user of client computer 204 unfolds. In this manner, the automated negotiation agent 206 may attempt to use the model of human negotiation behavior to construct and present offers to the human user of client computer 204 that the automated negotiation agent 206 believes the human user of client computer 204 is likely to accept and that are advantageous to the party on behalf of whom the automated negotiation agent 206 is negotiating.

Negotiations often involve a seller of some product or service and a potential buyer of that product or service dickering over the terms of sale/purchase of the product or service. In the context of an automated negotiation between an automated negotiation agent and a human counterpart, the automated negotiation agent may represent the seller with the potential buyer being a human.

To generalize the negotiation scenario, the two parties (e.g., the automated negotiation agent representing the seller and the human buyer) may be considered to negotiate over D issues (e.g., purchase price, quantity, and delivery time). At each negotiation round n, n≧1, the human buyer makes an offer, yₙ, to the automated negotiation agent. This offer, yₙ, may be represented by the automated negotiation agent as a D-dimensional real-valued vector with its d^{th} element, y_{n,d}, specifying the human buyer's offer for the d^{th} issue at round n. In response to the human buyer's offer, yₙ, at round n, the automated negotiation agent generally may take one of three actions: (i) continue the negotiation with a counteroffer, which, analogous to yₙ, the automated negotiation agent also may represent as a D-dimensional vector; (ii) terminate the negotiation by accepting the human buyer's offer yₙ; or (iii) terminate the negotiation by rejecting the human buyer's offer yₙ.

Typically, the human buyer may have a set of one or more target offers that the human buyer hopes the automated negotiation agent will accept but that the human buyer does not disclose—at least initially—to the automated negotiation agent. For example, in a scenario where two issues—price and delivery time—are being negotiated, the human buyer may have targets of (1) {$240, 2 weeks}, (2) {$220, 3 weeks}, and (3) {$160, 4 weeks}. By the very nature of negotiation, the human buyer may rarely ever offer one of its targets to the automated negotiation agent in the initial round of negotiation, i.e., at round n=1. Instead, at round n=1, the human buyer typically may make an offer that it finds more advantageous than any of its target values. For instance, a human buyer with a target of {$240, 2 weeks} may make an offer of {$200, 1 week} at round n=1. Thereafter, the human buyer's offers may follow a trajectory in the D-dimensional issue space from this initial offer towards one of the human buyer's target values. Because the human buyer may desire to obtain counteroffers from the automated negotiation agent that are more favorable to the buyer than the buyer's own target values, the trajectory of the human buyer's offers may never reach one of its target values. That is to say, the human buyer may never actually offer one of its target values.

In a negotiation involving D issues, the different possible combinations of terms included in an offer may be represented by a D-dimensional issue space. As a negotiation moves from one round to the next, the negotiation behavior of a human buyer may be tracked within the D-dimensional issue space. In addition, as a negotiation unfolds, the negotiation behavior of the human buyer may transition through multiple phases or states, s=1, 2, 3 . . . , where, at each state, s, the human buyer follows a different strategy. As the human buyer switches between strategies (e.g., employing a new strategy or returning to a previously-used strategy), the trajectory of the human buyer's negotiation behavior within the D-dimensional issue space changes.

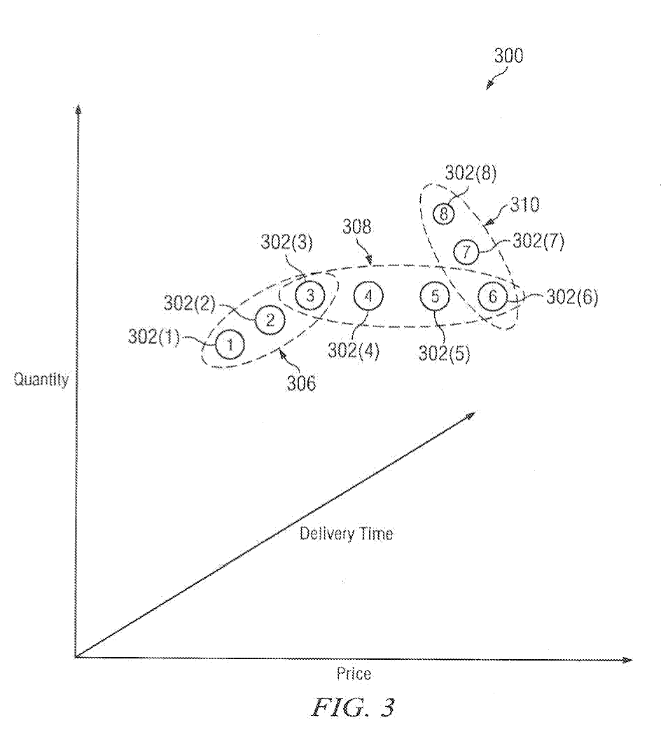

FIG. 3 is a graphical representation of an example of human buyer negotiation behavior in a 3-dimensional issue space 300 for a negotiation involving three issues, namely quantity, price, and delivery time. As illustrated in FIG. 3, the negotiation has progressed through 8 rounds, with the human buyer having proposed 8 different offers 302(1)-(8), one at each round of the negotiation. Initially, during the first three rounds of negotiation, as evidenced by offers 302(1)-302(3), the human buyer made small concessions in both quantity and price, while holding firm when it came to delivery time. Thereafter, in rounds four through six of the negotiation and as evidenced by offers 302(4)-302(6), the human buyer changed negotiation strategy, making larger concessions on price but holding firm on quantity and delivery time. Then, in rounds seven through eight of the negotiation and as evidenced by offers 302(7)-302(8), the human buyer again changed strategy, this time making concessions on quantity and delivery time, but requesting price reductions in exchange for those concessions.

As illustrated in FIG. 3, each time the human buyer changes strategy, the trajectory of the human buyer's negotiation behavior changes. For example, as discussed above, the human buyer's first three offers 302(1)-303(3) reflect a first strategy 306 and follow a first trajectory, while the human buyer's fourth through sixth offers 302(4)-302(6) reflect a second strategy 308 and follow a second trajectory, and the human buyer's seventh and eighth strategies reflect a third strategy 310 and follow a third trajectory.

During an automated negotiation with a human counterpart, an automated negotiation agent such as, for example, automated negotiation agent 206 illustrated in FIG. 2, may compare offers actually made by the human counterpart to a model of human negotiation behavior in an effort to both identify the trajectory of the human counterpart's negotiation behavior and to predict future offers to be made by the human counterpart. That is to say, given the human counterpart's offers between round n=0 and round n=T, where T is the current round, the automated negotiation agent attempts to predict the trajectory of the human counterpart's negotiation behavior for rounds n>T. The automated negotiation agent then can make counteroffers to its human counterpart that fall along (or within a vicinity of) this predicted trajectory as one of the human counterpart's targets likely falls along (or within a vicinity of) this predicted trajectory. In this fashion, the automated negotiation agent may be able to make counteroffers to its human counterpart that are favorable both to the human counterpart and the party on behalf of whom the automated negotiation agent is negotiating.

A switching linear dynamical system (SLDS), which is a variation of a linear dynamical system (LDS), may be used to model human negotiation behavior as described herein. While an LDS may be useful for modeling negotiation behavior in a D-dimensional issue space within a given state s, the fixed Gaussian model of the LDS may limit the usefulness of using an LDS to model negotiation behavior across multiple states. Therefore, an SLDS, which is a variation of the LDS where the fixed Gaussian model is replaced with a conditional Gaussian model, may be more useful in modeling negotiation behavior across multiple states.

When an SLDS is used to model negotiation behavior, the transition model may be given by:

xₙ=A(sₙ)xₙ₋₁+vₙ(sₙ), (Eq. 1)

yₙ=Cxₙ+wₙ, (Eq. 2)

p_{i,j}=P(sₙ=i|sₙ₋₁=j), (Eq. 3)

Where x₁ is Gaussian, xₙεR^{D} is the hidden LDS state at round n, yₙεR^{D} is the observation at round n, wₙεR^{D} is the Gaussian measurement noise, vₙ(sₙ)εR^{D} is the Gaussian state noise, A(sₙ)εR^{D×D} is the LDS state transition matrix, CεR^{D×D} is the LDS observation matrix, and p_{i,j} is the probability that at round n the human counterpart is in state i, while he was in state j at round n−1.

The joint distribution of X, Y and S is given by

P(y₁ⁿ,x₁ⁿ,s₁ⁿ)=ΠP(yₙ|xₙ)P(x₁|s₁)ΠP(xₙ|xₙ₋₁,sₙ)P(s₁)ΠP(sₙ|sₙ₋₁), (Eq. 4)

where y₁ⁿ denotes the sequence y₁, . . . , yₙ,; x₁ⁿ denotes the sequence x₁, . . . , xₙ; and s₁ⁿ denotes the sequence s₁, . . . , sₙ.

When using historical negotiation data to train an SLDS to model human negotiation behavior, the number of switching states of the SLDS model may not be known a priori. Instead, the model size (e.g., the number of switching states) may grow as new offers are encountered within the training set during training. Therefore, in order to accommodate an infinitely countable number of switching states, the SLDS model may be trained within a minimum description length (MDL) framework where the appropriate SLDS model for the training set is determined to be the SLDS model that minimizes the sum of the computational complexity of the model and the computational complexity of using the model to represent the data of the training set itself. For example, while modeling and learning the parameters of the infinite SLDS model, Shannon-optimal code lengths may be used to compute the minimum code length required for coding the observations y₁^{T}, and the appropriate SLDS model may be determined to be the model that minimizes the sum of the Shannon-optimal code lengths and the size of the codebook that shows the mapping between the training set data to be coded and the code. By employing this technique, the number of switching states of the SLDS model does not have to be pre-defined. Instead, it is determined through MDL minimization.

To understand how an SLDS can be trained within an MDL framework, consider that, given a set of hypotheses indexed by h, observed data y can be described with the hypothesis h using total code length l(y|h)+l(h), where l(h) is the minimum code length to describe the selected hypothesis h, and l(y|h) is the minimum code length to describe y according to the selected hypothesis h. Each hypothesis h induces a probability distribution on the observed data, and, from Kraft's inequality, we know that l(Y|j)=−log P(y|h) and l(h)=−log P(h). According to the MDL principle, the hypothesis that is selected to describe the observed data is the hypothesis h* that minimizes l(y|h)+l(h) among all h.

When the MDL framework is applied in the context of training an SLDS, the switching state, s, of the SLDS plays the role of the hypothesis h. This leads to the following code length for the SLDS given in Equations (1)-(4) at time T:

Σₙ₌₁^{T}l_{Θ}_{₁}(yₙ|y₁ⁿ⁻¹,s₁ⁿ)+Σₙ^{T}=₁l_{Θ}_{₂}(sₙ|sₙ₋₁), (Eq. 5)

where Θ₁ represents the parameters A(s), C, and the covariance matrices for v(s) and w, Θ₂ is the probability mass function p_{i,j}, l_{Θ}_{₁} maps yₙ|(yₙⁿ⁻¹, s₁ⁿ) to its minimum code length under Θ₁; and l_{Θ} maps sₙ|sₙ₋₁ to its minimum code length under Θ₂.

The codebook shows the mapping between the values of y and s and the code. In the context of applying the MDL principle to an infinite SLDS model, the size of the codebook may not be constant. Rather, as new switching states are discovered, the size of the codebook may grow. Thus, the size of the codebook may be included in the description length of the SLDS model. The description length of the SLDS model, therefore, is given by:

Σₙ₌₁^{T}l_{Θ}_{₁}(yₙ|y₁ⁿ⁻¹,s₁ⁿ)+Σₙ₌₁^{T}l_{Θ}_{₂}(sₙ|sₙ₋₁)+C_{Θ}_{₁}+C_{Θ}_{₂} (Eq. 6)

where C_{Θ}_{₁} represents the size of the codebook for the mapping between yₙ|(y₁ⁿ, s₁ⁿ) and its code, and C_{Θ}_{₂} represents the size of the codebook for the mapping between sₙ|sₙ₋₁ and its code. In other words C_{Θ}_{₁}+C_{Θ}_{₂} represents the computational complexity of the SLDS model and Σₙ₌₁^{T}l_{Θ}_{₁}(yₙ|y₁ⁿ⁻¹,s₁ⁿ)+Σₙ₌₁^{T}l_{Θ}_{₂}(sₙ|sₙ₋₁) represents the computational complexity of using the model to represent the data.

As discussed above, Shannon-optimal code lengths may be used to compute the length functions l. Thus,

l_{Θ}_{₁}(yₙ|y₁ⁿ⁻¹,s₁ⁿ)=−log(P(yₙ|y₁ⁿ⁻¹,s₁ⁿ)), (Eq. 7) and

l_{Θ}_{₂}(sₙ=k|sₙ₋₁=j)=−log(P(sₙ=k|sₙ₋₁=j)) (Eq. 8)

As yₙ|(y₁ⁿ⁻¹, s₁ⁿ) is real-valued, it may be quantized before coding. Since yₙ|(y₁ⁿ⁻¹, s₁ⁿ) is Gaussian, it can be shown that its quantized version can be coded with a Shannon optimal code length of approximately:

$$\frac{1}{2} log {( 2 π e )}^{D} \vert {Σ}_{{y}_{n \vert ( {y}_{1}^{n - 1} , {s}_{1}^{n} ) \vert}} \vert - log Δ , \qquad ( Eq . 9 )$$

where

$${\sum }_{{y}_{n \vert ( {y}_{1}^{n - 1} , {s}_{1}^{n} ) \vert}}$$

is the covariance matrix, and Δ is the volume of the quantization bin. In the SLDS setting, the quantization bin volume Δ may act as a parameter that controls the tendency to discover new states. As discussed in greater detail below, the process of adding new states to the SLDS model may involve minimizing Equation 6. Although it may appear that Δ would not have an effect on minimizing Equation 6, since log Δ is an additive constant, Δ influences the codebook size. In particular, as Δ is increased, the quantization gets coarser, and, thus, the expected code lengths for yₙ|(y₁ⁿ⁻¹, s₁ⁿ) generally decreases, which decreases the size of the codebook, leading to more switching states.

In addition, Δ has an actual meaning in the negotiation setting. As a result, the quantization bin may be set at values that are perceived as being small enough to preserve significant differences in the issue space. For example, if the seller of a laptop computer knows that a price difference of more than 50 dollars is very important to a buyer in a negotiation, then A may be set at a value below 50 dollars.

In order to train an SLDS model within the MDL framework, values for the parameters Θ₁ and Θ₂ that minimize Equation 6 may be determined using, for example, the generalized expectation-maximization (EM) algorithm. When the EM algorithm is used to minimize Equation 6, the expectation step (E-step) generally involves estimating the posterior probabilities of the hidden states x₁^{T} and the switching states s₁^{T} given the observations y₁^{T} and the parameters Θ₁ and Θ₂. The maximization step (M-step) then involves updating the parameters based on the results of the E-step.

Consider first the case where there are a fixed number of switching states. In particular, suppose n=T and that there are K states. During the E-step, the switching states s₁^{T} are set, and the posterior probabilities of x₁^{T} are computed. Denoting the minimum value of Equation 5 as H_{T,k} when the switching state sequence s₁^{T} ends with s_{T}=k, H_{T,k} can be computed recursively as:

$${H}_{n , k} = {min}_{j} {H}_{n - 1 , j} + {l}_{{Θ}_{1}} ( {y}_{n} \vert {y}_{1 }^{n - 1} , {s}_{1}^{n - 2 , *} ( j ) , {s}_{n - 1} = j , {s}_{n} = k ) + {l}_{{Θ}_{2}} ( {s}_{n } = k \vert {s}_{n - 1} = j ) , \qquad ( Eq . 10 )$$

where 1≦n≦T, and s₁ⁿ⁻²′*(j) is the switching state sequence that minimizes Hₙ₋₁ⱼ among all state sequences up to round n−2.

Applying the MDL principle, the second term on the right side of Equation 7 is given by −logP(yₙ|y₁ⁿ⁻¹,s₁ⁿ⁻²′*(j), sₙ₋₁=j,sₙ=k). This probability can be computed using the standard forward algorithm for the Gaussian LDS inference using the Θ₁ parameters estimated during the M-step. Similarly, the third term on the right side of Equation 10 is given by −logP(sₙ=k|sₙ₋₁=j) and can be computed using the Θ₂ parameters estimated during the M-step. After all of the costs H up to round n=T have been computed for every state, the index of the switching state that minimizes H_{T,k} is selected, and the switching states may be back-traced to find the appropriate sequence of S₁^{T}. Using the switching states and the posterior probabilities estimated from the standard LDS inference during the E-step, the parameters Θ₁ and Θ₂ are updated during the M-step.

This approach can be extended to the case where there are an unknown number of switching states a priori. According to the MDL principle, an observation is said to be unexplainable according to a set of hypothesis if, for every hypothesis in the set of hypotheses, the description length of the observation conditioned on the hypothesis is greater than the unconditional description length of the observation. Consequently, if

$$arg {min}_{k} {l}_{{Θ}_{1}} ( {y}_{n} \vert {y}_{1}^{n - 1} , {s}_{1}^{n - 1} , {s}_{n} = k ) > - log ( P ( {y}_{n} ) ) , \qquad ( Eq . 11 )$$

for every state k, 1≦k≦K, it may be determined that the existing switching model is insufficient to explain the observation yₙ. Stated differently, if the description length of the current SLDS model for describing the data of the training set is greater than Shannon's unconditional length for describing the data of the training set without a model, it may be determined that a new switching state should be added to the SLDS model. Therefore, if Equation 11 is satisfied, the time index n may be added to the set P of time steps with observations not explained by the current SLDS model.

Suppose there exist K states prior to time T, and the codebooks are C_{Θ}_{₁} and C_{Θ}_{₂} for the existing K-state SLDS model. In order to add a new state to the K-state SLDS model, a subset pεP and new codebooks C_{Θ}_{₁} and C_{Θ}_{₂} may be sought for the (K+1)-state SLDS model such that Equation 6 decreases when the observations in p are assigned to the new state K+1. In particular, a comparison may be performed to check if

$${min}_{k} {H}_{T , k} + {C}_{{Θ}_{1}} + {C}_{{Θ}_{2}} > {min}_{k} {\tilde{H}}_{T , k} + {\tilde{C}}_{{Θ}_{1}} + {\tilde{C}}_{{Θ}_{2}} , \qquad ( Eq . 12 )$$

where \tilde{H}_{T,k} has the same switching state sequence path as H_{T,k} except that the members of the subset p are assigned to the new state K+1. If Equation 12 is true, then, at time T, a new state K+1 may be added to the SLDS model.

The best subset p may be selected by trying multiple permutations of subsets of P and selecting the particular subset that minimizes the right-hand side of Equation 12. Due to the fact that the number of possible permutations of subsets of P may be large (i.e., there are 2^{|P|} permutations of subsets of P), the EM algorithm may be initialized using a subset selected from a small number of permutations. After the new subset p has been identified, the EM algorithm is applied to estimate the parameters, the switching states, and the posterior probabilities of the SLDS model.

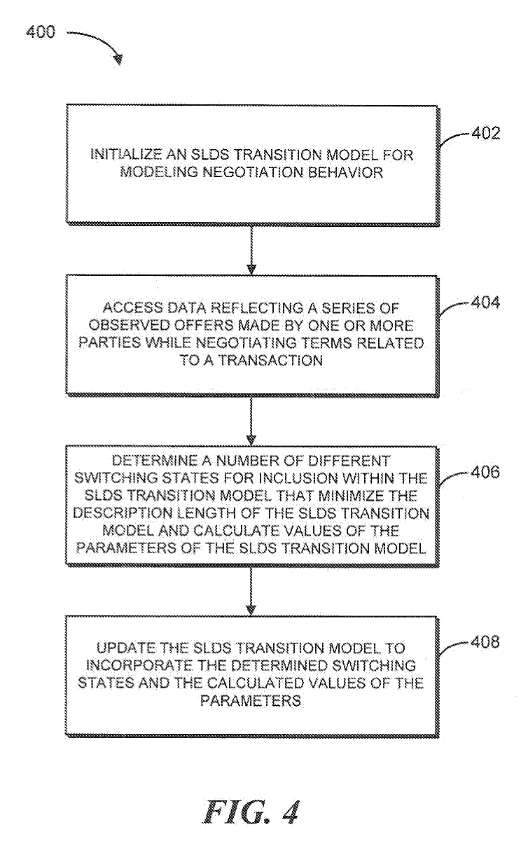

FIG. 4 is a flowchart 400 illustrating an example of a process for building a negotiation behavior model. In particular, the process may be performed to build an SLDS-based model of negotiation behavior for a particular type of transaction involving a specific number of issues. The process illustrated in the flowchart 400 of FIG. 4 may be performed by an electronic commerce system such as the electronic commerce complex 202 illustrated in FIG. 2. More specifically, the process illustrated in the flowchart 400 of FIG. 4 may be performed by one or more of the processors 210 of the computing device(s) that implement the electronic commerce complex 202 under control of negotiation behavior modeler 214.

At block 402, an SLDS transition model for modeling negotiation behavior is initialized. For example, an SLDS transition model as given in Equations 1-4 may be initialized.

In addition to initializing the SLDS transition model, at block 404, data is accessed that reflects a series of previously observed offers made by one or more parties while negotiating terms related to the specific type of transaction. For example, series of offers made by parties in previous negotiations related to the specific type of transaction and involving the same issues may be accessed from a computer memory storage system implementing a negotiation history repository such as, for example, computer memory storage system 212 of FIG. 2. Then, this data can be used as a training set for training the SLDS transition model to model negotiation behavior.

Specifically, at block 406, the data is applied to the SLDS model and the appropriate number of switching states to include within the SLDS transition model is determined by finding the number of switching states that minimizes the description length of the SLDS transition model for the data in the training set. In addition, at block 406, values of the parameters of the SLDS transition model also are calculated for the determined number of switching states in view of the data in the training set. For example, as described above, the EM algorithm may be used to determine the appropriate number s of switching states to model the data in the training set by minimizing Equation 6. In addition, the EM algorithm also may be used to calculate the values of the parameters Θ₁ (i.e., A(s), C, and the covariance matrices for v(s) and w) and Θ₂ (i.e., p_{i,j}) for the SLDS transition model given in Equations 1-4 in view of the determined number of switching states.

After the number of switching states to be included in the SLDS transition model has been determined and after the values of the parameters of the SLDS transition model have been calculated, at block 408, the SLDS transition model is updated to incorporate the determined switching states and the calculated values of the parameters for the SLDS transition model. This trained SLDS transition model for modeling human negotiation behavior involving the specific type of transaction then may be stored in a computer memory storage system such as, for example, the computer memory storage system 216 storing one or more negotiation behavior model(s). Thereafter, the stored SLDS transition model may be used by an automated negotiation agent, such as, for example, automated negotiation agent 206 of FIG. 2, to facilitate an automated negotiation of the particular type of transaction with a human counterpart.

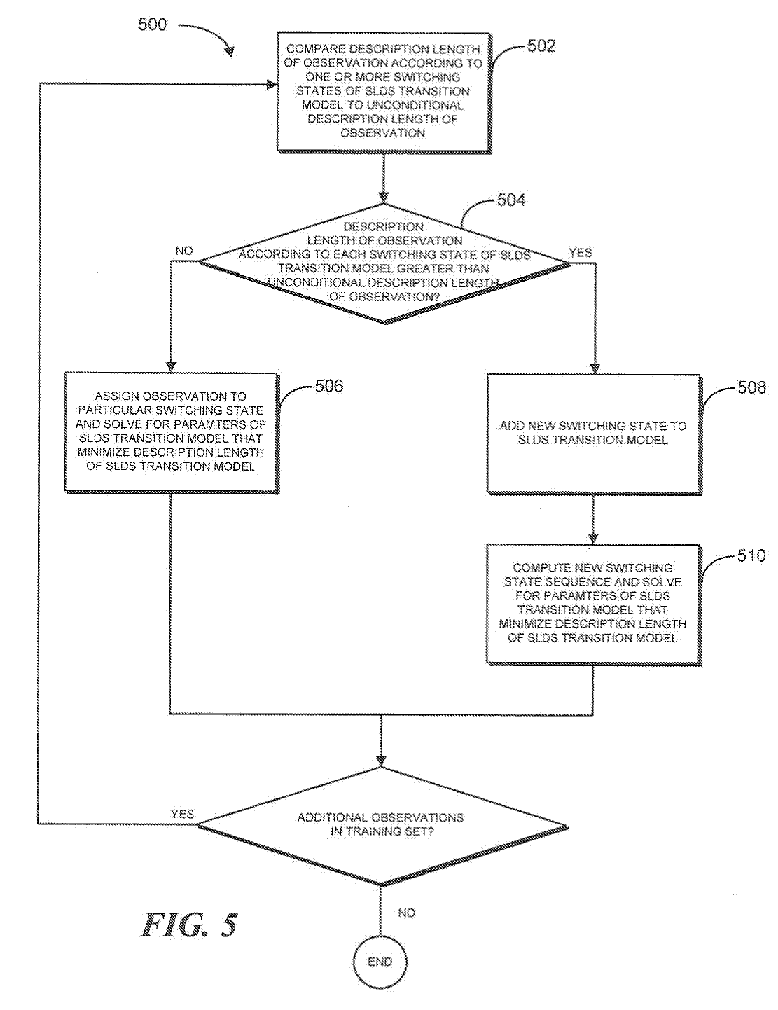

FIG. 5 is a flowchart 500 of an example of a process for both determining the appropriate number of switching states to incorporate within an SLDS model and calculating the parameters for the SLDS model in view of a training set of data. As such, the process illustrated in the flowchart 500 of FIG. 5 is one example of a process for performing the operations represented by block 406 in the flowchart 400 of FIG. 4. The process illustrated in the flowchart 500 of FIG. 5 may be performed by an electronic commerce system such as, for example, the electronic commerce complex 202 illustrated in FIG. 2. More specifically, the process illustrated in the flowchart 500 of FIG. 5 may be performed by one or more of the processors 210 of the computing device(s) that implement the electronic commerce complex 202 under control of negotiation behavior modeler 214.

The process illustrated in the flowchart 500 of FIG. 5 may be performed for each observation y within the training set. At step 502, the description length of an individual observation yₙ is assigned to one or more of the switching states of the SLDS transition model, and, then, for each switching state to which the observation yₙ is assigned, the description length of the observation is compared to the unconditional length of the observation yₙ. For example, the comparison given by Equation 11 is performed. Then, based on the results of these comparisons, a determination is made at block 504 as to whether the description length of the observation yₙ according to each switching state of the SLDS transition model is greater than the unconditional description length of the observation.

In the event that the description length of the observation yₙ, when it is assigned to one or more of the switching states of the current SLDS transition model, is less than the unconditional description length of the observation yₙ, at block 506, the observation is assigned to a particular one of the switching states of the SLDS model and the values of the parameters Θ₁ (i.e., A(s), C, and the covariance matrices for v(s) and w) and Θ₂ (i.e., p_{i,j}) for the SLDS transition model given in Equations 1-4 are computed by minimizing the description length of the SLDS transition model. For example, the observation may be assigned to a particular one of the switching states and the values of the parameters Θ₁ and Θ₂ may be calculated by using the EM algorithm to recursively solve Equation 7.

Alternatively, if the description length of the observation yₙ according to each switching state of the SLDS transition model is greater than the unconditional description length of the observation, at block 508, a new switching state is added to the SLDS transition model. In addition, at block 510, a new switching state sequence is computed and the values of the parameters Θ₁ (i.e., A(s), C, and the covariance matrices for v(s) and w) and Θ₂ (i.e., p_{i,j}) for the SLDS transition model given in Equations 1-4 are computed by minimizing the description length of the SLDS transition model. For example, the new switching state sequence and the values of the parameters Θ₁ and Θ₂ may be computed by constructing different permutations of observations for inclusion within the new switching state and using the EM algorithm to recursively solve Equation 7 for each of the different permutations of observations for inclusion within the new switching state. Then, the particular permutation that results in the shortest description length may be determined to be the best SLDS transition model.

After the SLDS model has been updated to account for the observation (e.g., either by performing the operations represented in box 506 or by performing the operations represented in boxes 508 and 510), a determination is made, at 512, as to whether additional observations remain in the training set. If one or more additional observations remain in the training set, the process illustrated in the flowchart 500 of FIG. 5 returns to box 502 and is repeated for each remaining observation. Alternatively, if there are no more observations remaining in the training set, the process ends.

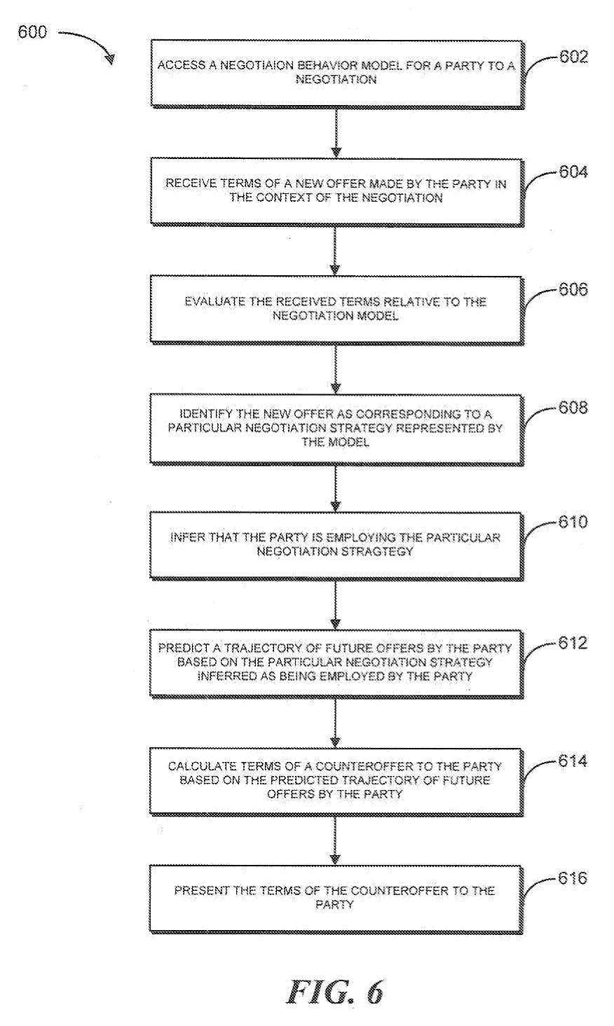

FIG. 6 is a flowchart 600 illustrating an example of a process for conducting an automated negotiation. In particular, the process may be performed to conduct an automated negotiation with a human counterpart over a particular type of transaction involving certain predefined issues. Furthermore, the process may involve the use of a model of human negotiation behavior that represents multiple different negotiation strategies in the issue space that potentially may be employed by the human counterpart during the negotiation process. Moreover, the process illustrated in the flowchart 600 of FIG. 6 may be performed by an electronic commerce system such as the electronic commerce complex 202 illustrated in FIG. 2. More specifically, the process illustrated in the flowchart 600 of FIG. 6 may be performed by one or more of the processors 210 of the computing device(s) that implement the electronic commerce complex 202 under control of automated negotiation agent 206.

At box 602, a negotiation behavior model is accessed that models different negotiation strategies for a negotiation related to the particular type of transaction and involving the predefined issues. For example an SLDS-based model of human negotiation behavior that uses different switching states to represent multiple different negotiation strategies in the issue space for the particular type of transaction may be accessed from a computer memory storage system, such as, for example the computer memory storage system 216 storing one or more negotiation behavior models of FIG. 2. In addition, terms of a new offer made by a party in the context of a negotiation related to the particular type of transaction and involving the predefined issues are received at box 604. For example, terms of a new offer may be made by a human counterpart via client computer 204 and received over network 208 of FIG. 2.

After receiving the terms of the new offer, the terms of the new offer are evaluated relative to the negotiation model at box 606, and, based on this evaluation, the new offer is identified, at box 608, as corresponding to a particular one of the negotiation strategies represented by the model of negotiation behavior. For example, the received terms of the new offer may be the same as or similar to terms that were within the training set of data used to train the model of negotiation behavior. If that is the case, the received terms of the new offer may be determined to be associated with the same negotiation strategy as the corresponding offer within the training set of data. Additionally or alternatively, the received terms of the new offer may be determined to fall along or within a short distance of the trajectory of a particular one of the negotiation strategies modeled by the negotiation behavior model. Consequently, the terms of the new offer may be identified as corresponding to this negotiation strategy.

At block 610, as a consequence of having identified the new offer as corresponding to the particular negotiation strategy, it is inferred that the party is employing the particular negotiation strategy. Thereafter, at block 612, the trajectory, in the issue space, of future offers to be made by the party are predicted based on the particular negotiation strategy inferred as being employed by the party. For example, after inferring that the particular negotiation strategy is being employed by the party, it may be predicted that future offers to be made by the party will fall along the trajectory of or in the same general direction as the particular strategy in the issue space.

At block 614, the terms of a counteroffer are calculated based on the predicted trajectory of future offers by the party, and, then, at block 616, the terms of the counteroffer are presented to the party. For example, terms that are deemed acceptable by the automated negotiation agent and that also fall along the trajectory of the particular negotiation strategy in the issue space may be determined and, thereafter, proposed to the party. If the terms of the counteroffer are accepted by the party, the automated negotiation may end. Alternatively, if the party proposes its own counteroffer, the process may be repeated in view of the terms of the new counteroffer, and the automated negotiation may continue in this fashion until one party either accepts an offer by the other party or decides to terminate the negotiation.

In some implementations, an automated negotiation agent engaged in a negotiation involving multiple different issues with an opposing party attempts to predict, at round T of the negotiation, the opposing party's future offers for rounds n>T based on the history of the opposing party's offers up to an including round T and/or based on other data used to model the opposing party's negotiation strategy (e.g., historical data reflecting other parties' negotiation histories). For example, the automated negotiation agent may employ a prediction model, such as an SLDS-based prediction model as described above, an LDS-based prediction model (e.g., a fixed-length LDS-based prediction model or an infinite-length LDS-based prediction model), a replication prediction model, or an autoregressive prediction model, to compute conditional probabilities of the future trajectories of the opposing party's offers for rounds n>T given the history of the opposing party's offers for rounds n≦T. The automated negotiation agent then may use the resulting conditional probabilities to select a counteroffer to propose to the opposing party that both is perceived to be favorable to the party on behalf of whom the automated negotiation agent is negotiating and for which the likelihood that the future trajectory of the opposing party's offers will intersect the counteroffer is substantial.

In one particular example, an automated negotiation agent has access to a list of D-element issue vectors, each of which specifies a different combination of values for D issues involved in the negotiation, that is rank-ordered according to preferences of the party on behalf of whom the automated negotiation agent is negotiating. In addition, the automated negotiation agent has access to a cut-off point in the list such that vectors that rank higher than the cut-off point are considered to be target vectors for the automated negotiation agent. At round T of the negotiation with the opposing party, the automated negotiation agent uses a prediction model (e.g., an SLDS-based prediction model as described above) to compute, for each target vector u, the probability q_{u,t} that the opposing party's future trajectory of offers will intersect the target vector u in the issue space for the negotiation within a given number t of additional rounds of negotiation (i.e. at or before round T+t) based on the opposing party's previous offer history.

The automated negotiation agent then identifies a subset of the target vectors for which the computed probabilities satisfy a condition as target vectors to be considered for presentation to the opposing party. For example, the automated negotiation agent may set a probability threshold Q and identify any target vector u for which the computed probability q_{u,t}>Q as a target vector to be considered for presentation to the opposing party. Additionally or alternatively, the automated negotiation agent may identify some threshold percentage (e.g., the top 20%) of the target vectors having the highest computed probabilities of intersecting the opposing party's future trajectory of offers as target vectors to be considered for presentation to the opposing party. Using the computed probabilities that the opposing party's future trajectory of offers will intersect the target vectors in the issue space within a given number t of additional rounds of negotiation to identify the subset of target vectors to be considered for presentation to the opposing party in this fashion may increase the likelihood of the opposing party accepting an offer ultimately presented to the opposing party.

After identifying this subset of target vectors to be considered for presentation to the opposing party, the automated negotiation agent then selects at least one of the subset of target vectors for presentation to the opposing party. For example, the automated negotiation agent may select the target vector from among the subset of target vectors for which the value of t is the lowest (i.e., the automated negotiation agent may select the target vector for which the computed probability will satisfy the predetermined condition in the fewest number of additional rounds of negotiation). Target vectors within the subset having relatively low values of t may be assumed to be more favorable to the opposing party than other target vectors within the subset having relatively high values of t. Therefore, selecting the target vector for which the value of t is the lowest may increase the likelihood that the opposing party will derive substantial utility from the target vector. As an alternative to selecting the target vector from among the subset of target vectors that has the lowest value of t, the automated negotiation agent may select the target vector from among the subset of target vectors that has the highest ranking within the rank-ordered list of issue vectors according to the preferences of the party represented by the automated negotiation agent.

In some implementations, the automated negotiation agent may compute a probability for each potential offer to be made to the opposing party that the opposing party will accept the potential offer within a given number of rounds of negotiation. The automated negotiation agent then may identify a subset of the potential offers for which the computed probabilities satisfy a condition (e.g., exceed a threshold probability value) within the given number of rounds of negotiation. Thereafter, the automated negotiation agent may identify the particular potential offer within the subset of potential offers having the highest computed probability as an offer to be presented to the opposing party.

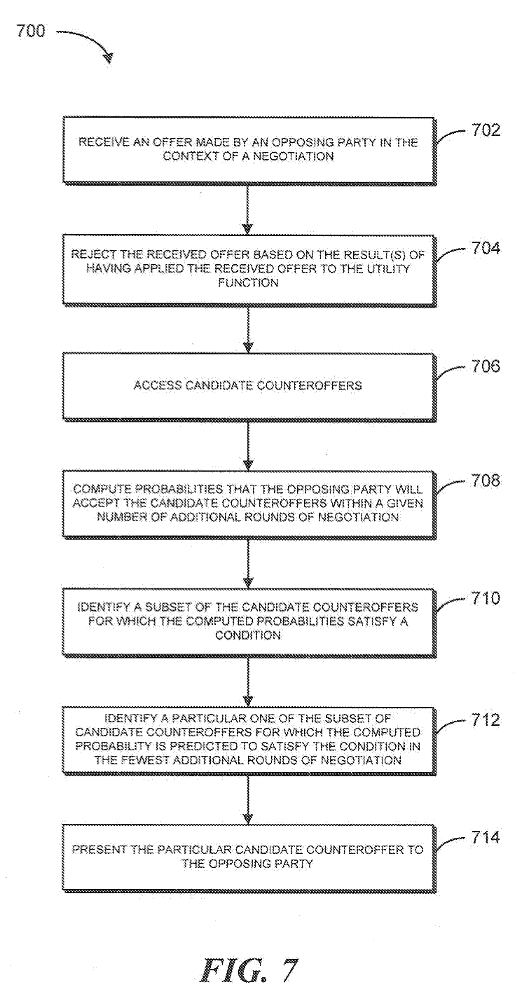

FIG. 7 is a flowchart 700 illustrating an example of a process for identifying a counteroffer to be presented to an opposing party in an automated negotiation. The process illustrated in the flowchart 700 of FIG. 7 may be performed by an electronic commerce system such as the electronic commerce complex 202 illustrated in FIG. 2. More specifically, the process illustrated in the flowchart 700 of FIG. 7 may be performed by one or more of the processors 210 of the computing device(s) that implement the electronic commerce complex 202 under control of automated negotiation agent 206.

At block 702, an offer made by an opposing party in the context of a negotiation is received. For example, if the negotiation involves some number D different issues where D≧2, a D-element vector specifying an offered term for each of the D issues involved in the negotiation may be received. Thereafter, at block 704, the received offer is rejected. In some implementations, the received offer may be applied to a utility function for the party on behalf of whom the automated negotiation agent is negotiating. If the result of applying the received offer to the utility function is that less than a threshold quantity of utility would be derived from the received offer, the received offer may be rejected.

At block 706, candidate counteroffers are accessed. In some implementations, accessing the candidate counteroffers may involve reducing a set of possible counteroffers down to a subset of candidate counteroffers that are perceived to be favorable to the party on behalf of whom the negotiation agent is negotiating. For example, the counteroffers within the set of possible counteroffers may be applied to a utility function for the party on behalf of whom the automated negotiation agent is negotiating, and those counteroffers that, when applied to the utility function, result in more than a threshold level of utility may be identified as candidate counteroffers. As discussed above in connection with the offer made by the opposing party that is received at block 702, the candidate counteroffers may be represented by D-element vectors specifying different combinations of terms for each of the D issues involved in the negotiation.

At block 708, probabilities that the opposing party will accept each of the candidate counteroffers within a given number of additional rounds of negotiation are computed. In some cases, the computation of the probabilities that the opposing party will accept each of the candidate counteroffers within the given number of additional rounds of negotiation may be based on previous offers made by the opposing party. Additionally or alternatively, the computation of the probabilities that the opposing party will accept each of the candidate counteroffers within the given number of additional rounds of negotiation may be based on historical negotiation data involving other opposing parties.

Furthermore, depending on the implementation, various different types of prediction models may be employed to compute the probabilities that the opposing party will accept each of the candidate counteroffers within the given number of additional rounds of negotiation. For example, in some implementations, a modified SLDS-based prediction model as described above may be employed to compute the probabilities that the opposing party will accept each of the candidate counteroffers within the given number of additional rounds of negotiation. Alternatively, in other implementations, an LDS-based prediction model (e.g., a fixed-length LDS-based prediction model or an infinite-length LDS-based prediction model), a replication prediction model, or an autoregressive prediction model may be used to compute the probabilities that the opposing party will accept each of the candidate counteroffers within the given number of additional rounds of negotiation.

In one particular example, each candidate counteroffer u may be represented by a D-element vector that specifies potential terms for each of D issues involved in the negotiation, and, at round T of the negotiation, an SLDS-based prediction model as described above may be employed to compute, for each counteroffer vector u, the probability q_{u,t} that the opposing party's future trajectory of offers will intersect the counteroffer vector u in the D-dimensional issue space at or before some round T+t based on the opposing party's previous offer history. In particular, the probability q_{u,t} that the opposing party's future trajectory of offers will intersect the counteroffer vector u in the D-dimensional issue space at or before some round T+t based on the opposing party's previous offer history may be computed according to the following algorithm:
(1) Generate a number L of potential future offer trajectories according to parameters computed for an SLDS-based prediction model, such as, for example, the SLDS-based prediction model described above in connection with Equations 1-3, where L is selected to be greater than the number of candidate counteroffers in the set.
(2) Where u is a particular candidate counteroffer, l is a particular one of the L potential future offer trajectories, and n is a particular number of additional rounds of negotiation, set B(u, l, n)=1 if the trajectory l passes through the candidate counteroffer u after exactly n additional rounds of negotiation. Otherwise, set B(u, l, n)=0.
(3) Compute

$${q}_{u , t} = \frac{{\sum }_{l = 1}^{L} G ( u , l )}{L}$$

where G is given by G(u, l)=1 if B(u, l, n)=1 at any time between n=1 to n=t, otherwise G(u, l)=0.

After the probabilities that the opposing party will accept the candidate counteroffers within the given number of rounds of negotiation have been computed, a subset of the candidate counteroffers for which the computed probabilities satisfy a condition is identified at block 710. In some implementations, the condition may be that the computed probability that the opposing party will accept the candidate counteroffer within the given number of rounds of negotiation is greater than some threshold probability value. Alternatively, in other implementations, the condition may be that the computed probability that the opposing party will accept the candidate counteroffer within the given number of rounds of negotiation is within some threshold percentage (e.g., top 20%) of the computed probabilities for all of the candidate counteroffers.

Then, at block 712, a particular one of the subset of candidate counteroffers for which the computed probability is predicted to satisfy the condition in the fewest number of additional rounds of negotiation is identified. For example, in implementations in which the condition is that the computed probability that the opposing party will accept the candidate counteroffer is greater than some threshold probability value, the candidate counteroffer for which the fewest number of additional rounds of negotiation result in the computed probability that the opposing party will accept the candidate counteroffer exceeding the threshold probability value may be identified. Thereafter, at block 714, the particular counteroffer may be presented to the opposing party for consideration in the context of the negotiation.

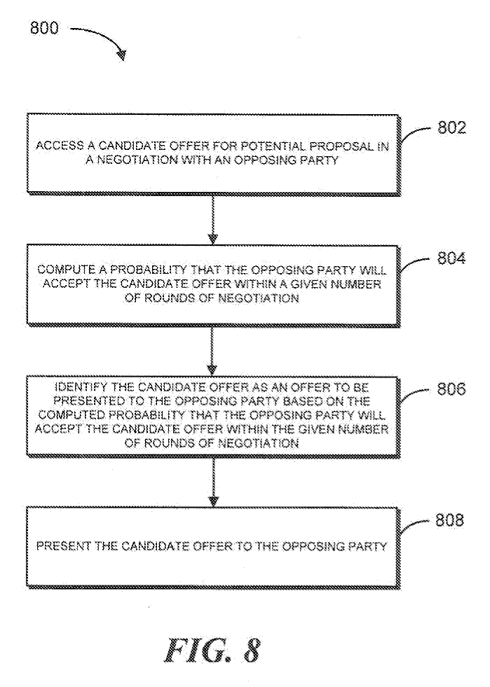

FIG. 8 is a flowchart 800 illustrating an example of a process for identifying an offer to be presented to an opposing party in an automated negotiation. The process illustrated in the flowchart 800 of FIG. 8 may be performed by an electronic commerce system such as the electronic commerce complex 202 illustrated in FIG. 2. More specifically, the process illustrated in the flowchart 800 of FIG. 8 may be performed by one or more of the processors 210 of the computing device(s) that implement the electronic commerce complex 202 under control of automated negotiation agent 206.

At block 802, a candidate offer for potential proposal in a negotiation with an opposing party is accessed. Then, at block 804, a probability that the opposing party will accept the candidate offer within a given number of rounds of negotiation is computed. For example, in some implementations, a prediction model that models the future trajectory of offers to be made by the opposing party in the issue space of the negotiation based on the previous offer history of the opposing party may be employed to compute a measure of the probability that the future trajectory of offers to be made by the opposing party will intersect the candidate offer in the issue space of the negotiation. Thereafter, at block 806, the candidate offer is identified as an offer to be presented to the opposing party based on the computed probability that the opposing party will accept the candidate offer within the given number of rounds of negotiation. For example, in some implementations, the candidate offer may be identified as an offer to be presented to the opposing party based on a determination that the computed probability that the opposing party will accept the candidate offer within the given number of rounds of negotiation exceeds a threshold probability value. As a consequence of having identified the candidate offer as an offer to be presented to the opposing party, at block 808, the candidate offer is presented to the opposing party.

A number of methods, techniques, systems, and apparatuses have been described. However, additional alternatives are contemplated. For example, while the techniques for automated negotiation described herein generally are described in the context of an automated negotiation agent negotiating on behalf of a seller of a product or service, the techniques can be applied equally well in the context of an automated negotiation agent negotiating on behalf of a buyer of a product or service. Furthermore, while the techniques for automated negotiation described herein generally are described in the context of an automated negotiation agent engaging in a negotiation with a human counterpart, the described techniques also could be applied by an automated negotiation agent engaged in a negotiation with another automated negotiation agent. That is to say, automated negotiation agents as described herein may be opposing-party agnostic. Moreover, the techniques for automated negotiation described herein are not necessarily limited to being applied to negotiations related to the sale/purchase of a product or service. Rather, the techniques for automated negotiation described herein may be applied in many different types of negotiation settings.

As described above, according to one general aspect, a switching linear dynamical system (SLDS) transition model having a number of parameters for modeling negotiation behavior of parties negotiating multiple terms of a transaction is initialized. In addition, data that reflects a series of observed offers made by parties while negotiating terms related to the transaction is accessed from a computer memory storage system. Thereafter, a number of different switching states are determined for inclusion within the SLDS transition model that reduces a description length of the SLDS transition model when the SLDS transition model is used to model the series of observed offers relative to a description length of the SLDS transition model when a different number of switching states are included within the SLDS transition model and the SLDS transition model is used to model the series of observed offers. Values of the parameters of the SLDS transition model also are calculated for modeling the series of observed offers when the determined switching states are included within the SLDS transition model. Finally, the SLDS transition model is updated to incorporate the determined switching states and the calculated values of the parameters.

Implementations may include one or more of the following features. For example, the SLDS transition model may be capable of including any number of switching states, the number of switching states to be included in the SLDS transition model may be unknown a priori, and/or switching states included within the SLDS transition model may describe different negotiation strategies inferred from the series of observed offers.

The number of different switching states to be included within the SLDS transition model may be determined by determining a number of different switching states for inclusion within the SLDS transition model that minimizes the description length of the SLDS transition model. Furthermore, the description length of the SLDS transition model may be a function of a sum of a length of the switching states included within the SLDS transition model and a code length of the SLDS transition model when the switching states are included within the SLDS transition model and the SLDS transition model is used to model the series of observed offers. As such, determining a number of different switching states for inclusion within the SLDS transition model that minimizes the description length of the SLDS transition model may include determining a number of different switching states for inclusion within the SLDS transition model that minimizes the sum of the length of the switching states and the code length of the SLDS transition model when the switching states are included within the SLDS transition model and the SLDS transition model is used to model the series of observed offers.

The transaction being negotiated may involve a product purchase. In such cases, data that reflects a series of observed offers made by parties while negotiating at least a price for and a quantity of the product to be purchased may be accessed. In addition, a number of different switching states may be determined for inclusion within the SLDS transition model when the SLDS transition model is used to model the series of observed offers of prices for and quantities of the product to be purchased, and values of the parameters of the SLDS transition model may be calculated for modeling the series of observed offers of prices for and quantities of the product to be purchased.

In some cases, the transaction may involve a purchase of one or more goods or services and the parties may be buyers. In such cases, an SLDS transition model for modeling negotiation behavior of buyers negotiating multiple terms of a purchase of one or more goods or services may be initialized, and data may be accessed that reflects a series of observed offers made by buyers while negotiating terms related to the purchase of one or more goods or services.

Alternatively, the transaction may be a sale of one or more goods or services and the parties may be sellers. In such cases, an SLDS transition model for modeling negotiation behavior of sellers negotiating multiple terms of a sale of one or more goods or services may be initialized, and data may be accessed that reflects a series of observed offers made by sellers while negotiating terms related to the sale of one or more goods or services.

According to another general aspect, data is stored that reflects a series of observed offers made by one or more parties while negotiating terms related to a transaction. In addition, the series of observed offers is used to train, within a minimum description length framework, a switching linear dynamical system (SLDS) transition model capable of accommodating any number of different switching states to model the series of observed offers.

Implementations may include one or more of the following features. For example, the SLDS transition model may be capable of accommodating a countably infinite number of different switching states to model the series of observed offers.

According to still another general aspect, a negotiation behavior model for a party to a negotiation that involves multiple terms is accessed. The accessed negotiation behavior model accommodates multiple different negotiation strategies and models different potential progressions of terms of offers by the party during the negotiation, where individual ones of the potential progressions of offers correspond to different negotiation strategies. Terms of a new offer made by the party in the context of the negotiation are received and evaluated relative to the negotiation behavior model. Based on evaluating the received terms, the new offer is identified as corresponding to a particular one of the negotiation strategies, and, as a consequence, it is inferred that the party is employing the particular negotiation strategy. A trajectory of future offers by the party then is predicted based on the particular negotiation strategy having been inferred as being employed by the party, terms of a counteroffer to the party are calculated based on the predicted trajectory of future offers by the party. The calculated terms of the counteroffer then are presented to the party.

Implementations may include one or more of the following features. For example, the negotiation may involve price for and quantity of a product to be purchased. As such, the negotiation behavior model may model different potential progressions of offers of prices for and quantities of the product to be purchased. In addition, a new offer of a particular price for and a particular quantity of the product to be purchased may be received and evaluated. In addition, the particular price for and the particular quantity of the product to be purchased may be evaluated relative to the negotiation behavior model, and at least one of a different price for and a different quantity of the product to be purchased may be calculated as terms for a counteroffer. At least one of the different price for and the different quantity of the product to be purchased then may be presented to the party. Furthermore, in some implementations, the negotiation may include at least three terms and the negotiation behavior model may model different potential progressions of offers for each of the at least three terms.

According to yet another aspect, candidate offers that specify different potential terms for a transaction are accessed and probabilities that an opposing party in a negotiation will accept the different candidate offers within a given number of additional rounds of negotiation are computed. A subset of the candidate offers (e.g., a subset of less than all of the candidate offers) for which the computed probabilities that the opposing party will accept the candidate offers within the given number of additional rounds of negotiation satisfy a condition then is identified. For the candidate offers in the subset of candidate offers, predictions are made as to the additional numbers of rounds of negotiation to occur before the computed probabilities that the opposing party will accept the candidate offers will satisfy the condition. Then, based on the predicted additional number of rounds of negotiation to occur before the computed probabilities that the opposing party will accept the candidate offers will satisfy the condition, a particular candidate offer is identified as a candidate offer to be presented to the opposing part and the particular candidate offer is presented to the opposing party.

Implementations may include one or more of the following features. For example, the negotiation may involve D≧2 issues, D≧3 issues, etc., where the D issues define a D-dimensional issue space. In such implementations, accessing candidate offers that specify different potential terms for the transaction may include accessing vectors in the D-dimensional issue space specifying different combinations of potential terms for the D issues, and computing probabilities that the opposing party in the negotiation will accept the different candidate offers within the given number of additional rounds of negotiation may include computing probabilities that the opposing party in the negotiation will accept the different combinations of potential terms for the D issues specified by the accessed vectors within the given number of additional rounds of negotiation. Similarly, identifying a subset of the candidate offers for which the computed probabilities that the opposing party will accept the candidate offers within the given number of additional rounds of negotiation satisfy the condition may include identifying a subset of the candidate offers for which the computed probabilities that the opposing party will accept the different combinations of potential terms for the D issues specified by the accessed vectors within the given number of additional rounds of negotiation satisfy the condition, predicting, for the candidate offers in the subset of candidate offers, additional numbers of rounds of negotiation to occur before the computed probabilities that the opposing party will accept the candidate offers will satisfy the condition may include predicting, for the candidate offers in the subset of candidate offers, additional numbers of rounds of negotiation to occur before the computed probabilities that the opposing party will accept the different combinations of potential terms for the D issues specified by the accessed vectors within the given number of additional rounds of negotiation will satisfy the condition, and identifying a particular candidate offer as a candidate offer to be presented to the opposing party based on the predicted number of additional rounds of negotiation to occur before the computed probabilities that the opposing party will accept the candidate offers will satisfy the condition may include identifying a particular offer as a candidate offer to be presented to the opposing party based on the predicted number of additional rounds of negotiation to occur before the computed probabilities that the opposing party will accept the different combinations of potential terms for the D issues specified by the accessed vectors will satisfy the condition.

In some implementations, computing probabilities that the opposing party in the negotiation will accept the different combinations of potential terms for the D issues specified by the accessed vectors may include computing probabilities, using a prediction model that models a future trajectory of offers by the opposing party in the issue space (e.g., based on previous offers made by the opposing party), that the future trajectory of offers by the opposing party in the D-dimensional issue space will intersect the accessed vectors within the given number of additional rounds of negotiation, and identifying a subset of the candidate offers for which the computed probabilities that the opposing party will accept the different combinations of potential terms for the D issues specified by the accessed vectors within the given number of additional rounds of negotiation satisfy the condition may include identifying a subset of the candidate offers for which the computed probabilities that the future trajectory of offers by the opposing party in the D-dimensional issue space will intersect the accessed vectors within the given number of additional rounds of negotiation satisfy the condition. Similarly, predicting, for the candidate offers in the subset of candidate offers, additional numbers of rounds of negotiation to occur before the computed probabilities that the opposing party will accept the different combinations of potential terms for the D issues specified by the accessed vectors within the given number of additional rounds of negotiation will satisfy the condition may include predicting, for the candidate offers in the subset of candidate offers, additional numbers of rounds of negotiation to occur before the computed probabilities that the future trajectory of offers by the opposing party in the D-dimensional issue space will intersect the accessed vectors within the given number of additional rounds will satisfy the condition, and identifying a particular offer as a candidate offer to be presented to the opposing party based on the predicted number of additional rounds of negotiation to occur before the computed probabilities that the opposing party will accept the different combinations of potential terms for the D issues specified by the accessed vectors will satisfy the condition may include identifying a particular offer as a candidate offer to be presented to the opposing party based on the predicted number of additional rounds of negotiation to occur before the computed probabilities that the future trajectory of offers by the opposing party in the D-dimensional issue space will intersect the accessed vectors. For example, the candidate offer that is predicted to intersect the future trajectory of offers by the opposing party in the fewest number of rounds of negotiation may be identified as the particular offer to be presented to the opposing party.

Furthermore, identifying a subset of the candidate offers for which the computed probabilities that the future trajectory of offers by the opposing party in the D-dimensional issue space will intersect the accessed vectors within the given number of additional rounds of negotiation satisfy the condition may include identifying a subset of the candidate offers for which the computed probabilities that the future trajectory of offers by the opposing party in the D-dimensional issue space will intersect the accessed vectors exceed a predetermined value. Additionally or alternatively, identifying a subset of the candidate offers for which the computed probabilities that the future trajectory of offers by the opposing party in the D-dimensional issue space will intersect the accessed vectors within the given number of additional rounds of negotiation satisfy the condition may include identifying some threshold percentage of the candidate offers for which the computed probabilities that the future trajectory of offers by the opposing party in the D-dimensional issue space will intersect the accessed vectors within the given number of additional rounds of negotiation are highest relative to the computed probabilities that the future trajectory of offers by the opposing party in the D-dimensional issue space will intersect the accessed vectors within the given number of additional rounds of negotiation for the other candidate counter offers.

Additionally or alternatively, in some implementations, an indication of an offer made by the opposing party that specifies proposed terms for the transaction may be received and a determination may be made to reject the offer made by the opposing party. In such implementations, candidate counteroffers that specify different potential terms for the transaction may be accessed as a consequence of determining to reject the offer made by the opposing party. Furthermore, computing probabilities that the opposing party in the negotiation will accept the different candidate offers within the given number of additional rounds of negotiation may include computing probabilities that the opposing party in the negotiation will accept the different candidate counteroffers within the given number of additional rounds of negotiation, and identifying the subset of the candidate offers for which the computed probabilities that the opposing party will accept the candidate offers within the given number of additional rounds of negotiation satisfy the condition may include identifying a subset of the candidate counteroffers for which the computed probabilities that the opposing party will accept the candidate counteroffers within the given number of additional rounds of negotiation satisfy the condition. Similarly, predicting, for the candidate offers in the subset of candidate offers, additional numbers of rounds of negotiation to occur before the probabilities that the opposing party will accept the candidate offers will satisfy the condition may include predicting, for the candidate counteroffers in the subset of candidate counteroffers, additional numbers of rounds of negotiation to occur before the probabilities that the opposing party will accept the candidate counteroffers will satisfy the condition, identifying the particular candidate offer as the candidate offer to be presented to the opposing party may include identifying a particular counteroffer as a candidate counteroffer to be presented to the opposing party, and causing the particular candidate offer to be presented to the opposing party may include causing the particular candidate counteroffer to be presented to the opposing party.

According to another general aspect, a candidate offer specifying potential terms for a transaction is accessed, a probability that an opposing party in a negotiation will accept the terms of the candidate offer within a given number of rounds of the negotiation is computed, the candidate offer is identified as an offer to present to the opposing party based on the computed probability, and the candidate offer is presented to the opposing party.

Implementations may include one or more of the following features. For example, the negotiation may involve D≧2 issues, where the D issues define a D-dimensional issue space. In such implementations, accessing a candidate offer specifying potential terms for a transaction may include accessing a vector in the D-dimensional issue space representing a candidate offer and specifying potential terms for the D issues, and computing a probability that the opposing party will accept the terms of the candidate offer within the given number of rounds of the negotiation may include computing a probability that a future trajectory of offers made by the opposing party in the issue space will intersect the accessed vector. Furthermore, in some implementations, it may be determined that the computed probability that the future trajectory of offers made by the opposing party in the issue space will intersect the accessed vector satisfies a condition, and identifying the candidate offer as an offer to present to the opposing party based on the computed probability may include identifying the candidate offer as an offer to present to the opposing party based on having determined that the computed probability that the future trajectory of offers made by the opposing party in the issue space will intersect the accessed vector satisfies a condition. Moreover, a number of additional rounds of negotiation before the computed probability that the future trajectory of offers made by the opposing party in the issue space will intersect the accessed vector will satisfy a condition may be predicted, and identifying the candidate offer as an offer to present to the opposing party based on the computed probability that a future trajectory of offers made by the opposing party in the issue space will intersect the accessed vector may include identifying the candidate offer as an offer to present to the opposing party based on the predicted number of additional rounds of negotiation before the computed probability that the future trajectory of offers made by the opposing party in the issue space will intersect the accessed vector will satisfy the condition.

According to still another general aspect, candidate offers that specify different potential terms for a transaction are accessed, probabilities that an opposing party in a negotiation will accept the different candidate offers after additional rounds of negotiation are computed, a subset of the candidate offers for which the computed probabilities that the opposing party will accept the candidate offers within a given number of additional rounds of negotiation exceed a threshold value are identified based on the computed probabilities that the opposing party will accept the different candidate offers after additional rounds of negotiation, and a particular candidate offer is identified from among the subset of candidate offers for which the computed probabilities that the opposing party will accept the candidate offers within the given number of additional rounds of negotiation exceed the threshold value, as having a greatest computed probability that the opposing party will accept it within the given number of additional rounds of negotiation relative to the computed probabilities that the opposing party will accept the other candidate offers within the given number of additional rounds of negotiation. The particular candidate offer then is presented to the opposing party.

The described methods, techniques, systems, and apparatuses may be implemented in digital electronic circuitry or computer hardware, for example, by executing instructions stored in computer-readable storage media.

Apparatuses implementing these techniques may include appropriate input and output devices, a computer processor, and/or a tangible computer-readable storage medium storing instructions for execution by a processor.

A process implementing techniques disclosed herein may be performed by a processor executing instructions stored on a tangible computer-readable storage medium for performing desired functions by operating on input data and generating appropriate output. Suitable processors include, by way of example, both general and special purpose microprocessors. Suitable computer-readable storage devices for storing executable instructions include all forms of non-volatile memory, including, by way of example, semiconductor memory devices, such as Erasable Programmable Read-Only Memory (EPROM), Electrically Erasable Programmable Read-Only Memory (EEPROM), and flash memory devices; magnetic disks such as fixed, floppy, and removable disks; other magnetic media including tape; and optical media such as Compact Discs (CDs) or Digital Video Disks (DVDs). Any of the foregoing may be supplemented by, or incorporated in, specially designed application-specific integrated circuits (ASICs).

Although the operations of the disclosed techniques may be described herein as being performed in a certain order or in certain combinations, in some implementations, individual operations may be rearranged in a different order, combined with different operations described herein, and/or eliminated and desired results still may be achieved. Similarly, components in the disclosed systems may be combined in a different manner and/or replaced or supplemented by other components and the desired results still may be achieved.

What is claimed is:

1. A computer-implemented method comprising:
accessing candidate offers that specify different potential terms for a transaction;
computing probabilities that an opposing party in a negotiation will accept the different candidate offers within a given number of additional rounds of negotiation;
identifying a subset of the candidate offers for which the computed probabilities that the opposing party will accept the candidate offers within the given number of additional rounds of negotiation satisfy a condition;
predicting, for the candidate offers in the subset of candidate offers, additional numbers of rounds of negotiation to occur before the computed probabilities that the opposing party will accept the candidate offers will satisfy the condition;
based on the predicted additional number of rounds of negotiation to occur before the computed probabilities that the opposing party will accept the candidate offers will satisfy the condition, identifying a particular candidate offer as a candidate offer to be presented to the opposing party; and
causing the particular candidate offer to be presented to the opposing party.

2. The method of claim 1 wherein:
the negotiation involves D≧2 issues, the D issues defining a D-dimensional issue space;
accessing candidate offers that specify different potential terms for the transaction includes accessing vectors in the D-dimensional issue space specifying different combinations of potential terms for the D issues;
computing probabilities that the opposing party in the negotiation will accept the different candidate offers within the given number of additional rounds of negotiation includes computing probabilities that the opposing party in the negotiation will accept the different combinations of potential terms for the D issues specified by the accessed vectors within the given number of additional rounds of negotiation;
identifying a subset of the candidate offers for which the computed probabilities that the opposing party will accept the candidate offers within the given number of additional rounds of negotiation satisfy the condition includes identifying a subset of the candidate offers for which the computed probabilities that the opposing party will accept the different combinations of potential terms for the D issues specified by the accessed vectors within the given number of additional rounds of negotiation satisfy the condition;
predicting, for the candidate offers in the subset of candidate offers, additional numbers of rounds of negotiation to occur before the computed probabilities that the opposing party will accept the candidate offers will satisfy the condition includes predicting, for the candidate offers in the subset of candidate offers, additional numbers of rounds of negotiation to occur before the computed probabilities that the opposing party will accept the different combinations of potential terms for the D issues specified by the accessed vectors within the given number of additional rounds of negotiation will satisfy the condition; and
identifying a particular candidate offer as a candidate offer to be presented to the opposing party based on the predicted number of additional rounds of negotiation to occur before the computed probabilities that the opposing party will accept the candidate offers will satisfy the condition includes identifying a particular offer as a candidate offer to be presented to the opposing party based on the predicted number of additional rounds of negotiation to occur before the computed probabilities that the opposing party will accept the different combinations of potential terms for the D issues specified by the accessed vectors will satisfy the condition.

3. The method of claim 2 wherein:
computing probabilities that the opposing party in the negotiation will accept the different combinations of potential terms for the D issues specified by the accessed vectors includes computing probabilities, using a prediction model that models a future trajectory of offers by the opposing party in the issue space, that the future trajectory of offers by the opposing party in the D-dimensional issue space will intersect the accessed vectors within the given number of additional rounds of negotiation;
identifying a subset of the candidate offers for which the computed probabilities that the opposing party will accept the different combinations of potential terms for the D issues specified by the accessed vectors within the given number of additional rounds of negotiation satisfy the condition includes identifying a subset of the candidate offers for which the computed probabilities that the future trajectory of offers by the opposing party in the D-dimensional issue space will intersect the accessed vectors within the given number of additional rounds of negotiation satisfy the condition;
predicting, for the candidate offers in the subset of candidate offers, additional numbers of rounds of negotiation to occur before the computed probabilities that the opposing party will accept the different combinations of potential terms for the D issues specified by the accessed vectors within the given number of additional rounds of negotiation will satisfy the condition includes predicting, for the candidate offers in the subset of candidate offers, additional numbers of rounds of negotiation to occur before the computed probabilities that the future trajectory of offers by the opposing party in the D-dimensional issue space will intersect the accessed vectors within the given number of additional rounds will satisfy the condition; and
identifying a particular offer as a candidate offer to be presented to the opposing party based on the predicted number of additional rounds of negotiation to occur before the computed probabilities that the opposing party will accept the different combinations of potential terms for the D issues specified by the accessed vectors will satisfy the condition includes identifying a particular offer as a candidate offer to be presented to the opposing party based on the predicted number of additional rounds of negotiation to occur before the computed probabilities that the future trajectory of offers by the opposing party in the D-dimensional issue space will intersect the accessed vectors.

4. The method of claim 3 wherein identifying a subset of the candidate offers for which the computed probabilities that the future trajectory of offers by the opposing party in the D-dimensional issue space will intersect the accessed vectors within the given number of additional rounds of negotiation satisfy the condition includes identifying a subset of less than all of the candidate offers for which the computed probabilities that the future trajectory of offers by the opposing party in the D-dimensional issue space will intersect the accessed vectors within the given number of additional rounds of negotiation satisfy the condition.

5. The method of claim 4 wherein identifying a subset of less than all of the candidate offers for which the computed probabilities that the future trajectory of offers by the opposing party in the D-dimensional issue space will intersect the accessed vectors within the given number of additional rounds of negotiation satisfy the condition includes identifying a subset of the candidate offers for which the computed probabilities that the future trajectory of offers by the opposing party in the D-dimensional issue space will intersect the accessed vectors exceed a predetermined value.

6. The method of claim 4 wherein identifying a subset of less than all of the candidate offers for which the computed probabilities that the future trajectory of offers by the opposing party in the D-dimensional issue space will intersect the accessed vectors within the given number of additional rounds of negotiation satisfy the condition includes identifying some threshold percentage of the candidate offers for which the computed probabilities that the future trajectory of offers by the opposing party in the D-dimensional issue space will intersect the accessed vectors within the given number of additional rounds of negotiation are highest relative to the computed probabilities that the future trajectory of offers by the opposing party in the D-dimensional issue space will intersect the accessed vectors within the given number of additional rounds of negotiation for the other candidate counter offers.

7. The method of claim 3 wherein identifying the particular offer as the candidate offer to be presented to the opposing party based on the predicted number of additional rounds of negotiation to occur before the computed probabilities that the future trajectory of offers by the opposing party in the D-dimensional issue space will intersect the accessed vectors includes identifying the particular offer as the candidate offer for which the predicted number of additional rounds of negotiation to occur before the computed probability that the future trajectory of offers by the opposing party in the D-dimensional issue space will intersect its corresponding vector is less than or equal to the predicted number of additional rounds of negotiation to occur before the computed probabilities that the future trajectory of offers by the opposing party in the D-dimensional issue space will intersect the accessed vectors corresponding to the other candidate offers.

8. The method of claim 3 wherein computing probabilities, using a prediction model that models a future trajectory of offers by the opposing party in the issue space, that the future trajectory of offers by the opposing party in the D-dimensional issue space will intersect the accessed vectors within the given number of additional rounds of negotiation includes computing probabilities, using a prediction model that models the future trajectory of offers by the opposing party in the issue space based on previous offers made by the opposing party, that the future trajectory of offers by the opposing party in the D-dimensional issue space will intersect the accessed vectors within the given number of additional rounds of negotiation.

9. The method of claim 2 wherein D 3.

10. The method of claim 1 further comprising:
receiving an indication of an offer made by the opposing party, the offer made by the opposing party specifying proposed terms for the transaction; and
determining to reject the offer made by the opposing party, wherein:
accessing candidate offers that specify different potential terms for the transaction comprises accessing candidate counteroffers that specify different potential terms for the transaction as a consequence of determining to reject the offer made by the opposing party,
computing probabilities that the opposing party in the negotiation will accept the different candidate offers within the given number of additional rounds of negotiation includes computing probabilities that the opposing party in the negotiation will accept the different candidate counteroffers within the given number of additional rounds of negotiation;
identifying the subset of the candidate offers for which the computed probabilities that the opposing party will accept the candidate offers within the given number of additional rounds of negotiation satisfy the condition includes identifying a subset of the candidate counteroffers for which the computed probabilities that the opposing party will accept the candidate counteroffers within the given number of additional rounds of negotiation satisfy the condition;
predicting, for the candidate offers in the subset of candidate offers, additional numbers of rounds of negotiation to occur before the probabilities that the opposing party will accept the candidate offers will satisfy the condition includes predicting, for the candidate counteroffers in the subset of candidate counteroffers, additional numbers of rounds of negotiation to occur before the probabilities that the opposing party will accept the candidate counteroffers will satisfy the condition;
identifying the particular candidate offer as the candidate offer to be presented to the opposing party includes identifying a particular counteroffer as a candidate counteroffer to be presented to the opposing party; and
causing the particular candidate offer to be presented to the opposing party includes causing the particular candidate counteroffer to be presented to the opposing party.

11. A non-transitory, computer-readable storage medium storing instructions that, when executed by a computer system, cause the computer system to:
access a candidate offer specifying potential terms for a transaction;
compute a probability that an opposing party in a negotiation will accept the terms of the candidate offer within a given number of rounds of the negotiation;
based on the computed probability, identify the candidate offer as an offer to present to the opposing party; and
cause the candidate offer to be presented to the opposing party.

12. The computer-readable storage medium of claim 11 wherein:
the negotiation involves D≧2 issues, the D issues defining a D-dimensional issue space;
the instructions that, when executed by a computer system, cause the computer system to access a candidate offer specifying potential terms for a transaction include instructions that, when executed by a computer system, cause the computer system to access a vector in the D-dimensional issue space representing a candidate offer and specifying potential terms for the D issues; and
the instructions that, when executed by a computer system, cause the computer system to compute a probability that the opposing party will accept the terms of the candidate offer within the given number of rounds of the negotiation include instructions that, when executed by a computer system, cause the computer system to compute a probability that a future trajectory of offers made by the opposing party in the issue space will intersect the accessed vector.

13. The computer-readable storage medium of claim 12 further comprising instructions that, when executed by a computer system, cause the computer system to determine that the computed probability that the future trajectory of offers made by the opposing party in the issue space will intersect the accessed vector satisfies a condition, wherein:
the instructions that, when executed by a computer system, cause the computer system to identify the candidate offer as an offer to present to the opposing party based on the computed probability include instructions that, when executed by a computer system, cause the computer system to identify the candidate offer as an offer to present to the opposing party based on having determined that the computed probability that the future trajectory of offers made by the opposing party in the issue space will intersect the accessed vector satisfies a condition.

14. The computer-readable storage medium of claim 12 further comprising instructions that, when executed by a computer system, cause the computer system to predict a number of additional rounds of negotiation before the computed probability that the future trajectory of offers made by the opposing party in the issue space will intersect the accessed vector will satisfy a condition, wherein:
the instructions that, when executed by a computer system, cause the computer system to identify the candidate offer as an offer to present to the opposing party based on the computed probability that a future trajectory of offers made by the opposing party in the issue space will intersect the accessed vector include instructions that, when executed by a computer system, cause the computer system to identify the candidate offer as an offer to present to the opposing party based on the predicted number of additional rounds of negotiation before the computed probability that the future trajectory of offers made by the opposing party in the issue space will intersect the accessed vector will satisfy the condition.

15. A system comprising:
one or more processing elements; and
computer memory storing instructions that, when executed by the one or more processing elements, cause the processing elements to:
access candidate offers that specify different potential terms for a transaction;
compute probabilities that an opposing party in a negotiation will accept the different candidate offers after additional rounds of negotiation;
identify, based on the computed probabilities that the opposing party will accept the different candidate offers after additional rounds of negotiation, a subset of the candidate offers for which the computed probabilities that the opposing party will accept the candidate offers within a given number of additional rounds of negotiation exceed a threshold value; and
identify, from among the subset of candidate offers for which the computed probabilities that the opposing party will accept the candidate offers within the given number of additional rounds of negotiation exceed the threshold value, a particular candidate offer as having a greatest computed probability that the opposing party will accept it within the given number of additional rounds of negotiation relative to the computed probabilities that the opposing party will accept the other candidate offers within the given number of additional rounds of negotiation; and
cause the particular candidate offer to be presented to the opposing party.
